(19) United States
(12) Patent Application Publication
(10) Pub. No.: US 2022/0188544 A1
(43) Pub. Date: Jun. 16, 2022

(54) GRASS DETECTION DEVICE AND METHOD THEREOF

(71) Applicant: ULSee Inc., Taipei City (TW)

(72) Inventor: Yi-Ta WU, Taipei City (TW)

(73) Assignee: ULSee Inc., Taipei City (TW)

(21) Appl. No.: 17/117,387

(22) Filed: Dec. 10, 2020

(51) Int. Cl. G06K 9/00; G06K 9/46; G05D 1/02

(52) U.S. Cl. CPC G06K 9/00657; G06K 9/00791; G05D 2201/0208; G05D 1/0219; G05D 1/0251; G06K 9/4652

(57) ABSTRACT

A grass detection device is provided in the present invention. The grass detection device includes a camera drone and an image processing unit. The camera drone, for shooting an area to obtain an aerial image data. The image processing unit is configured to perform binarization operations on the aerial image data to finally obtain a grass ground binarization image data, and then compare the aerial image data with the grass ground binarization image data for marking a part of the aerial image data that belongs to the grass ground to finally obtain a grass detection image data.

### FIELD OF THE INVENTION

The present invention relates to the technical field of image recognition technology, in particular, to a grass detection device and method thereof.

### BACKGROUND OF THE INVENTION

The maintenance, and pruning of the grassland are very heavy, especially for grass with a wide range such as golf courses, it is a heavy task that requires a lot of manpower. In order to reduce the workload of grassland-related work, someone began to design automated machines, such as lawn mowers. And, this automatic lawn mower mainly requires arrangement of a boundary line along the outline of the grass ground, and the automatic lawn mower will detect the boundary line during the mowing process to know the range of mowing.

However, the shortcoming of this automatic lawn mower is that before mowing, the marginal line should be arranged on the contour of the grass with man power to allow the automatic lawn mower to mow automatically. Although some people propose to use a camera drone to take pictures of the mowing area and then cooperate with the GPS positioning system to let the lawn mower automatically mow the weeds within the set range, it is still an important issue that the system can directly determine the range of the grass ground after the camera drone shoots. Therefore, the inventor began to think about solutions to this problem.

### SUMMARY OF THE INVENTION

The problem solved by the present invention is how to judge the range of the part that belongs to the grass ground in the image shot by the camera drone.

According to a first embodiment, a grass detection device is provided in the present invention. The grass detection device includes a camera drone and an image processing unit. The camera drone, for shooting an area to obtain an aerial image data. The image processing unit, communicatively connected to the camera drone, wherein the image processing unit is configured to perform binarization operations on the aerial image data according to a formula as below:

$$H = \{ \begin{matrix}θ & G \geq B \\ 360 - θ & G \leq B\end{matrix} \\ S = 1 - \frac{3}{R + G + B} [ min ( R , G , B ) ] \\ V = \frac{1}{3} ( R + G + B ) \\ θ = {cos}^{- 1} \{ \frac{2 R - G - B}{2 \sqrt{{( R - G )}^{2} + ( R - B ) ( G - B )}} \} \\ Image = Image\_H ⊗ Image\_S ⊗ Image\_I , and \\ \{ \begin{matrix}Image ( x , y ) = 1 , H ∈ [ 0 .2 , 0.45 ] , S ∈ [ 0.2 , 0.65 ] , I ∈ [ 0.25 , 1 ] \\ Image ( x , y ) = 0 , others\end{matrix} ,$$

to finally obtain a grass ground binarization image data, and then compare the aerial image data with the grass ground binarization image data for marking a part of the aerial image data that belongs to the grass ground to finally obtain a grass detection image data.

According to a second embodiment, a grass detection method is provided in the present invention. The method includes steps of:

(1) shooting a region to obtain an aerial image data with a camera drone;

(2) performing, with the image processing unit, binarization operations on the aerial image data according to a formula as below:

$$H = \{ \begin{matrix}θ & G \geq B \\ 360 - θ & G \leq B\end{matrix} \\ S = 1 - \frac{3}{R + G + B} [ min ( R , G , B ) ] \\ V = \frac{1}{3} ( R + G + B ) \\ θ = {cos}^{- 1} \{ \frac{2 R - G - B}{2 \sqrt{{( R - G )}^{2} + ( R - B ) ( G - B )}} \} \\ Image = Image\_H ⊗ Image\_S ⊗ Image\_I , and \\ \{ \begin{matrix}Image ( x , y ) = 1 , H ∈ [ 0 .2 , 0.45 ] , S ∈ [ 0.2 , 0.65 ] , I ∈ [ 0.25 , 1 ] \\ Image ( x , y ) = 0 , others\end{matrix} ,$$

finally obtaining a grass ground binarization image data; and

(3) comparing, with the image processing unit, the aerial image data with the grass ground binarization image data for marking a part of the aerial image data that belongs to the grass ground to finally obtain a grass detection image data.

Compared with the prior art, the present invention has the following creative features:

the image processing unit performs the binarization on the aerial image data through a series of formulas to determine a part of the aerial image data that belongs to the grass ground to finally obtain the grass ground binarization image data, and then marks the part of the aerial image data that belongs to the grass ground, i.e., mainly marking the part of the frame that belongs to the grass ground in the aerial image data for finally obtaining the grass detection image data. As such, the machine can learn which parts of the aerial image data belong to the grass ground, so as to facilitate subsequent maintenance, trimming, and maintenance of the grass ground with other machines.

### BRIEF DESCRIPTION OF THE DRAWINGS

FIG. 1 is a view showing a connection of various components of the present invention;

FIG. 2 is a flow chart of steps of the present invention;

FIG. 3 is a view showing a spiral motion path.

### DESCRIPTION OF REFERENCE SIGNS

### Detail Descriptions

In order to make the purpose and advantages of the invention clearer, the invention will be further described below in conjunction with the embodiments. It should be understood that the specific embodiments described here are only used to explain the invention, and are not used to limit the invention.

It should be understood that in the description of the invention, orientations or position relationships indicated by terms upper, lower, front, back, left, right, inside, outside and the like are orientations or position relationships are based on the direction or position relationship shown in the drawings, which is only for ease of description, rather than indicating or implying that the device or element must have a specific orientation, be constructed and operated in a specific orientation, and therefore cannot be understood as a limitation of the invention.

Further, it should also be noted that in the description of the invention, terms “mounting”, “connected” and “connection” should be understood broadly, for example, may be fixed connection and also may be detachable connection or integral connection;

may be mechanical connection and also may be electrical connection; and may be direct connection, also may be indirection connection through an intermediary, and also may be communication of interiors of two components. Those skilled in the art may understand the specific meaning of terms in the invention according to specific circumstance.

### Embodiment 1

The present invention relates to a grass detection device, which includes: a camera drone 1:

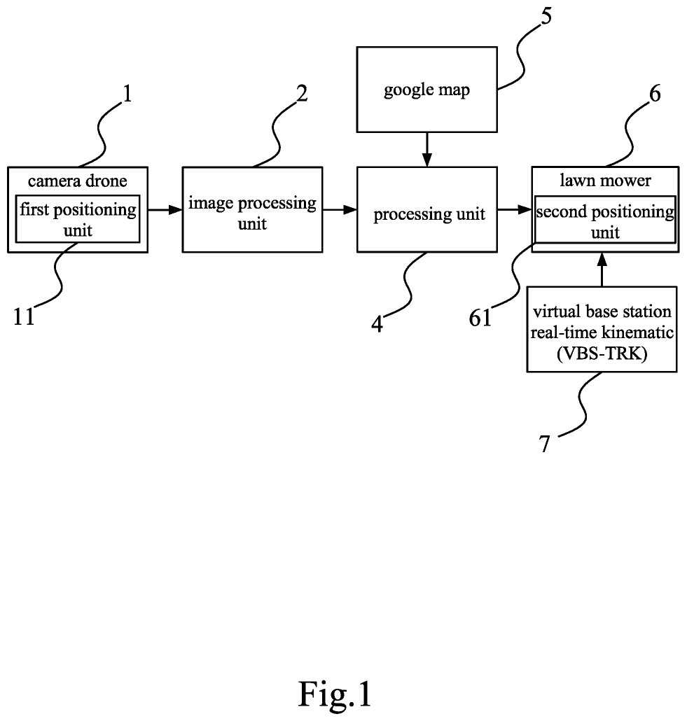

with reference to FIG. 1, the camera drone 1 is configured to shoot a region to obtain an aerial image data; the region may be street scenes, green areas, and mountain areas that have the grass ground, which are mainly shot according to user needs;

an image processing unit 2:

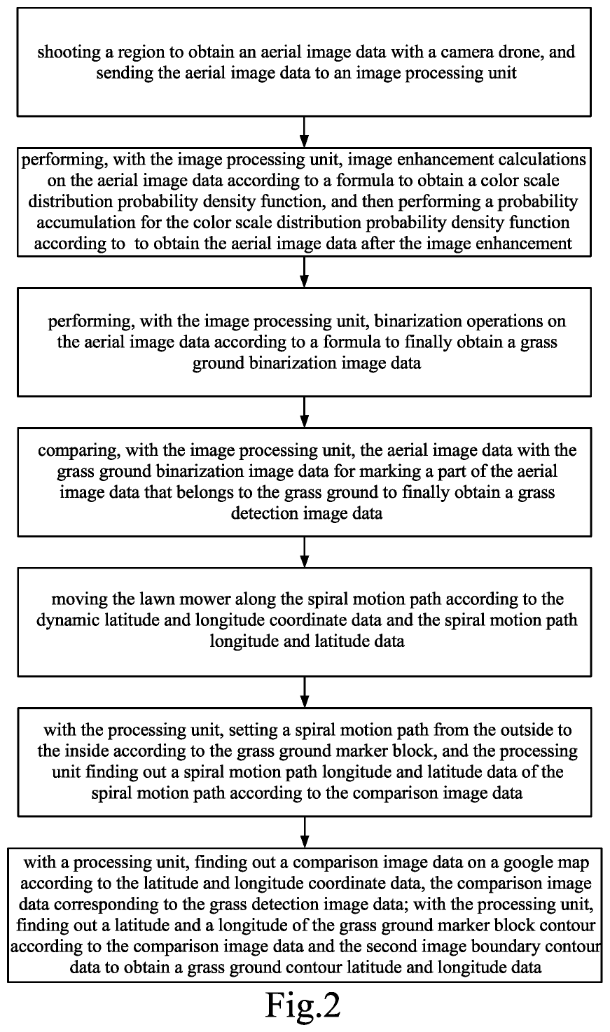

with reference to FIGS. 1 and 2, the image processing unit 2 is communicatively connected to the camera drone 1, wherein the image processing unit 2 is configured to perform binarization operations on the aerial image data according to a formula as below:

$$H = \{ \begin{matrix}θ & G \geq B \\ 360 - θ & G \leq B\end{matrix} \\ S = 1 - \frac{3}{R + G + B} [ min ( R , G , B ) ] \\ V = \frac{1}{3} ( R + G + B ) \\ θ = {cos}^{- 1} \{ \frac{2 R - G - B}{2 \sqrt{{( R - G )}^{2} + ( R - B ) ( G - B )}} \} \\ Image = Image\_H ⊗ Image\_S ⊗ Image\_I , and \\ \{ \begin{matrix}Image ( x , y ) = 1 , H ∈ [ 0 .2 , 0.45 ] , S ∈ [ 0.2 , 0.65 ] , I ∈ [ 0.25 , 1 ] \\ Image ( x , y ) = 0 , others\end{matrix} ,$$

to finally obtain a grass ground binarization image data, and then compare the aerial image data with the grass ground binarization image data for marking a part of the aerial image data that belongs to the grass ground to finally obtain a grass detection image data.

In the present invention, the aerial image data is subjected to a series of operations according to a formula, and then the part of the aerial image data belonging to the grass ground is binarized, so that the grass ground binarization image data may clearly show which parts of the aerial image data belong to the grass ground. Then, the image processing unit 2 marks the part of the aerial image data that belongs to the grass ground according to the grass ground binarization image data, i.e. mainly marking the part of the frame that belongs to the grass ground in the aerial image data for finally obtaining the grass detection image data. It is worth mentioning that the present invention, by setting a range value belonging to the grass color, with the above formula:

$$\{ \begin{matrix}Image ( x , y ) = 1 , H ∈ [ 0 .2 , 0.45 ] , S ∈ [ 0.2 , 0.65 ] , I ∈ [ 0.25 , 1 ] \\ Image ( x , y ) = 0 , others\end{matrix} ,$$

effectively highlights the part of the aerial image data that belongs to the grass ground.

As such, the machine can learn which parts of the aerial image data belong to the grass ground, so as to facilitate subsequent maintenance, trimming, and maintenance of the grass ground with other machines. At the same time, the grass detection image data may also enable relevant grass detection personnel, surveying personnel, etc., to clearly know which blocks belong to the grass ground through the grass detection image data.

### Embodiment 2

With reference to FIGS. 1 and 2, before the aerial image data is subjected to the binarization operations, preferably image enhancement operations are performed first mainly by long-strip enhancement, so that the contrast in the aerial image data is more obvious, which facilitates the effect of above binarization, and more effectively highlights the part of the aerial image data that belongs to the grass ground. To this end, the present invention may be implemented as below: with the image processing unit 2, a color scale distribution probability density function (p(f)) of the aerial image is obtained according to

$$p ( f ) = \frac{\begin{matrix}The number of occurrences of \\ the grayscale value of the aerial image\end{matrix} }{The total prime number of the aerial image} ,$$

and then a probability accumulation is performed for the color scale distribution probability density function according to

$$s = \int p ( f ) df and \{ \begin{matrix}{s}_{0} = p ( 0 ) \\ {s}_{i} = p ( i ) + {s}_{i - 1}\end{matrix} , wherein i = 1 , 2 , … ,$$

fmax, and fmax is 2^{image digits}; then, operations are performed according to gi=sᵢ*fₘₐₓ to obtain the aerial image data (gᵢ) after the image enhancement.

In this way, after the aerial image data is enhanced, the contrast of the image becomes more obvious, making the overall grass detection result better.

### Embodiment 3

When the present invention is used for automatic grass maintenance, and pruning, the part of the second image boundary contour data that belongs to the grass ground may be recognized, and then the coordinate position may be marked for subsequent automatic grass maintenance, and pruning. To this end, the present invention may be further implemented as below: the camera drone 1 is provided with a first positioning unit 11, and the first positioning unit 11 may be configured to measure latitude and longitude coordinates of the camera drone 1, so that the aerial image data includes a latitude and longitude coordinate data; the second image boundary contour data includes a grass ground marker block 8; a processing unit 4 finds out a comparison image data on a google map 5 according to the latitude and longitude coordinate data, and the comparison image data corresponds to the grass detection image data; the processing unit 4 finds out a latitude and a contour longitude of the grass ground marker block 8 according to the comparison image data and the grass detection image data to obtain a grass ground contour latitude and longitude data.

Since the google map 5 has the latitude and longitude information of each image location, the contour latitude and longitude of the grass ground contour block 8 in the second image boundary contour data may be found in a simplest way through the present invention without using the positioning unit to detect the latitude and longitude along the contour of the grass ground marker block 8 one by one, so that the lawn may be automatically maintained, and pruned through automated robots.

### Embodiment 4

With reference to FIGS. 1 and 2, the device is further provided with a lawn mower 6, the lawn mower 6 is communicatively connected to the processing unit 4, the lawn mower 6 is provided with a second positioning unit 61, the second positioning unit 61 may be configured to be communicatively connected to a virtual base station real-time kinematic 7 (VBS-TRK) for acquiring a dynamic latitude and longitude coordinate data of the lawn mower 6; the lawn mower 6 moves according to the dynamic latitude and longitude coordinate data and the grass ground contour latitude and longitude data.

After the above grass ground contour latitude and longitude data is obtained by the present invention, the grass ground contour latitude and longitude data may be used to make the lawn mower 6 automatically perform actions such as mowing within the grass range, and a very accurate positioning effect may be obtained through the virtual base station real-time kinematic 7 during the action, so that the overall positioning error is in the centimeter level, and the overall mowing effect is better.

### Embodiment 5

With reference to FIGS. 1, 2 and 3, the processing unit 4 sets a spiral motion path from the outside to the inside according to the grass ground marker block, and the processing unit 4 finds out a spiral motion path longitude and latitude data of the spiral motion path according to the comparison image data; the lawn mower 6 moves along the spiral motion path according to the dynamic latitude and longitude coordinate data and the spiral motion path longitude and latitude data.

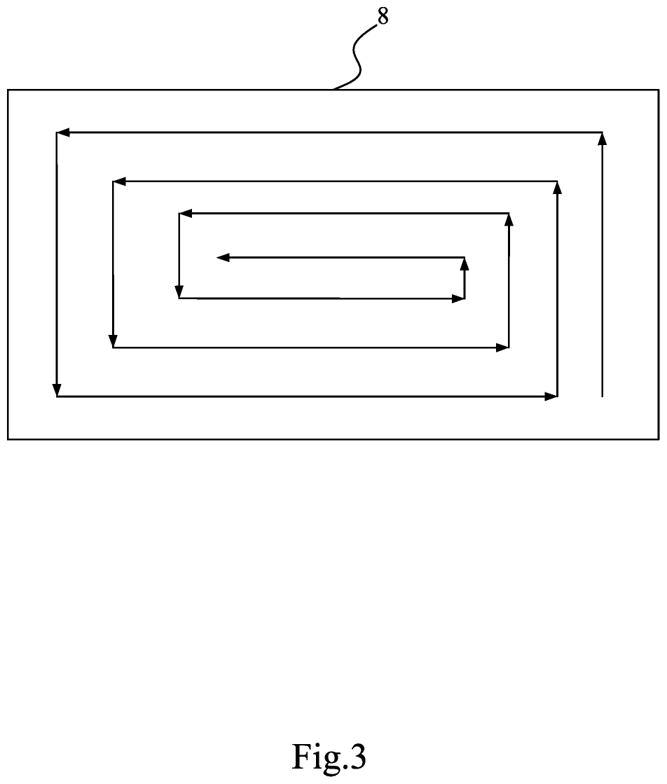

With reference to FIG. 3, the lawn mower 6 starts mowing grass from the outermost contour in the grass ground marker block, and may effectively mow all the grass in the grass ground marker block without being easily missed with the spiral motion from the outside to the inside; at the same time, with the spiral motion mode, in addition to having the best mowing effect, the time required for mowing may be reduced to improve the overall mowing effect and efficiency as compared to the irregular mowing ways. The arrow in FIG. 3 indicates the spiral motion path.

According to Article 31 of the Patent Law, the specification also proposes a grass detection method; since the advantages and characteristics related description of the grass detection method are similar to the foregoing grass detection device, the following description only introduces the grass detection method, and the description of the related advantages and characteristics will not be repeated. The grass detection method includes steps of:

(1) shooting a region to obtain an aerial image data with a camera drone;

(2) performing, with the image processing unit, binarization operations on the aerial image data according to a formula as below:

$$H = \{ \begin{matrix}θ & G \geq B \\ 360 - θ & G \leq B\end{matrix} \\ S = 1 - \frac{3}{R + G + B} [ min ( R , G , B ) ] \\ V = \frac{1}{3} ( R + G + B ) \\ θ = {cos}^{- 1} \{ \frac{2 R - G - B}{2 \sqrt{{( R - G )}^{2} + ( R - B ) ( G - B )}} \} \\ Image = Image\_H ⊗ Image\_S ⊗ Image\_I , and \\ \{ \begin{matrix}Image ( x , y ) = 1 , H ∈ [ 0 .2 , 0.45 ] , S ∈ [ 0.2 , 0.65 ] , I ∈ [ 0.25 , 1 ] \\ Image ( x , y ) = 0 , others\end{matrix} ,$$

finally obtaining a grass ground binarization image data;

(3) comparing, with the image processing unit, the aerial image data with the grass ground binarization image data for marking a part of the aerial image data that belongs to the grass ground to finally obtain a grass detection image data.

### Embodiment 1

Between the steps (1) and (2), a step (4) of, is further added: performing, with the image processing unit, image enhancement calculations on the aerial image data according to a formula

$$p ( f ) = \frac{\begin{matrix}The number of occurrences of \\ the grayscale value of the aerial image\end{matrix} }{The total prime number of the aerial image}$$

to obtain a color scale distribution probability density function (p(f)), and then performing a probability accumulation for the color scale distribution probability density function according to

$$s = \int p ( f ) df and \{ \begin{matrix}{s}_{0} = p ( 0 ) \\ {s}_{i} = p ( i ) + {s}_{i - 1}\end{matrix} , wherein i = 1 , 2 , … ,$$

fmax, and fmax is 2^{image digits}; then, performing operations according to gᵢ=sᵢ*fₘₐₓ to obtain the aerial image data (gᵢ) after the image enhancement.

### Embodiment 2

In the step (1), the camera drone is provided with a first positioning unit, the first positioning unit measures latitude and longitude coordinates of the camera drone while the camera drone is shooting for the aerial image data to comprise a latitude and longitude coordinate data; in the step (3), the grass detection image data comprises a grass ground marker block; the step (3) is added with a step (5) of: with a processing unit, finding out a comparison image data on a google map according to the latitude and longitude coordinate data, the comparison image data corresponding to the grass detection image data, the processing unit finding out a latitude and a longitude of the grass ground marker block contour block according to the comparison image data and the grass detection image data to obtain a grass ground contour latitude and longitude data.

### Embodiment 3

The step (5) is further added with a step (6) of: connecting communicatively the lawn mower to the processing unit, and providing the lawn mower with a second positioning unit, wherein the second positioning unit may be configured to be communicatively connected to a virtual base station real-time kinematic (VBS-TRK) for acquiring a dynamic latitude and longitude coordinate data of the lawn mower; the lawn mower moves according to the dynamic latitude and longitude coordinate data and the grass ground contour latitude and longitude data.

### Embodiment 4

Between the step (5) and the step (6), a step (7) of, is further added: with the processing unit, setting a spiral motion path from the outside to the inside according to the grass ground marker block, and the processing unit finding out a spiral motion path longitude and latitude data of the spiral motion path according to the comparison image data; in the step (6), the lawn mower moves along the spiral motion path according to the dynamic latitude and longitude coordinate data and the spiral motion path longitude and latitude data.

What is claimed is:

1. A grass detection device, comprising:
a camera drone, for shooting an area to obtain an aerial image data;
an image processing unit, communicatively connected to the camera drone, wherein the image processing unit is configured to perform binarization operations on the aerial image data according to a formula as below:
$$H = \{ \begin{matrix}θ & G \geq B \\ 360 - θ & G \leq B\end{matrix} \\ S = 1 - \frac{3}{R + G + B} [ min ( R , G , B ) ] \\ V = \frac{1}{3} ( R + G + B ) \\ θ = {cos}^{- 1} \{ \frac{2 R - G - B}{2 \sqrt{{( R - G )}^{2} + ( R - B ) ( G - B )}} \} \\ Image = Image\_H ⊗ Image\_S ⊗ Image\_I , and \\ \{ \begin{matrix}Image ( x , y ) = 1 , H ∈ [ 0 .2 , 0.45 ] , S ∈ [ 0.2 , 0.65 ] , I ∈ [ 0.25 , 1 ] \\ Image ( x , y ) = 0 , others\end{matrix} ,$$
to finally obtain a grass ground binarization image data, and then compare the aerial image data with the grass ground binarization image data for marking a part of the aerial image data that belongs to the grass ground to finally obtain a grass detection image data.

2. The grass detection device according to claim 1, wherein before the aerial image data is subjected to the binarization operations, image enhancement calculations are performed first, a color scale distribution probability density function (p(f)) of the aerial image is obtained according to
$$p ( f ) = \frac{\begin{matrix}The number of occurrences of \\ the grayscale value of the aerial image\end{matrix} }{The total prime number of the aerial image} ,$$
and then a probability accumulation is performed for the color scale distribution probability density function according to
$$s = \int p ( f ) df and \{ \begin{matrix}{s}_{0} = p ( 0 ) \\ {s}_{i} = p ( i ) + {s}_{i - 1}\end{matrix} ,$$
wherein i=1, 2, . . . , fmax, and fmax is 2^{image digits}; then, operations are performed according to gᵢ=sᵢ*fₘₐₓ to obtain the aerial image data (gᵢ) after the image enhancement.

3. The grass detection device according to claim 2, wherein the camera drone is provided with a first positioning unit, the first positioning unit may be configured to measure latitude and longitude coordinates of the camera drone, and the aerial image data comprises a latitude and longitude coordinate data; the grass detection image data comprises a grass ground marker block; a processing unit finds out a comparison image data on a google map according to the latitude and longitude coordinate data, and the comparison image data corresponds to the grass detection image data; the processing unit finds out a latitude and a longitude of the grass ground marker block contour according to the comparison image data and the second image boundary contour data to obtain a grass ground contour latitude and longitude data.

4. The grass detection device according to claim 3, wherein the device is further provided with a lawn mower, the lawn mower is communicatively connected to the processing unit, the lawn mower is provided with a second positioning unit, the second positioning unit may be configured to be communicatively connected to a virtual base station real-time kinematic (VBS-TRK) for acquiring a dynamic latitude and longitude coordinate data of the lawn mower; the lawn mower moves according to the dynamic latitude and longitude coordinate data and the grass ground contour latitude and longitude data.

5. The grass detection device according to claim 3, wherein the processing unit sets a spiral motion path from the outside to the inside according to the grass ground marker block, and the processing unit finds out a spiral motion path longitude and latitude data of the spiral motion path according to the comparison image data; the lawn mower moves along the spiral motion path according to the dynamic latitude and longitude coordinate data and the spiral motion path longitude and latitude data.

6. A grass detection method, comprising steps of:
(1) shooting a region to obtain an aerial image data with a camera drone;
(2) performing, with the image processing unit, binarization operations on the aerial image data according to a formula as below:
$$H = \{ \begin{matrix}θ & G \geq B \\ 360 - θ & G \leq B\end{matrix} \\ S = 1 - \frac{3}{R + G + B} [ min ( R , G , B ) ] \\ V = \frac{1}{3} ( R + G + B ) \\ θ = {cos}^{- 1} \{ \frac{2 R - G - B}{2 \sqrt{{( R - G )}^{2} + ( R - B ) ( G - B )}} \} \\ Image = Image\_H ⊗ Image\_S ⊗ Image\_I , and \\ \{ \begin{matrix}Image ( x , y ) = 1 , H ∈ [ 0 .2 , 0.45 ] , S ∈ [ 0.2 , 0.65 ] , I ∈ [ 0.25 , 1 ] \\ Image ( x , y ) = 0 , others\end{matrix} ,$$
finally obtaining a grass ground binarization image data; and
(3) comparing, with the image processing unit, the aerial image data with the grass ground binarization image data for marking a part of the aerial image data that belongs to the grass ground to finally obtain a grass detection image data.

7. The grass detection method according to claim 6, wherein between the steps (1) and (2), a step (4) of, is further added: performing, with the image processing unit, image enhancement calculations on the aerial image data according to a formula
$$p ( f ) = \frac{\begin{matrix}The number of occurrences of \\ the grayscale value of the aerial image\end{matrix} }{The total prime number of the aerial image}$$
to obtain a color scale distribution probability density function (p(f)), and then performing a probability accumulation for the color scale distribution probability density function according to s=∫p(f)df and
$$\{ \begin{matrix}{s}_{0} = p ( 0 ) \\ {s}_{i} = p ( i ) + {s}_{i - 1}\end{matrix} ,$$
wherein i=1, 2, . . . , fmax, and fmax is 2^{image digits}; then, performing operations according to gᵢ=sᵢ*fₘₐₓ to obtain the aerial image data (gᵢ) after the image enhancement.

8. The grass detection method according to claim 7, wherein in the step (1), the camera drone is provided with a first positioning unit, the first positioning unit measures latitude and longitude coordinates of the camera drone while the camera drone is shooting for the aerial image data to comprise a latitude and longitude coordinate data; in the step (3), the grass detection image data comprises a grass ground marker block; the step (3) is added with a step (5) of: with a processing unit, finding out a comparison image data on a google map according to the latitude and longitude coordinate data, the comparison image data corresponding to the grass detection image data, the processing unit finding out a latitude and a longitude of the grass ground marker block contour block according to the comparison image data and the grass detection image data to obtain a grass ground contour latitude and longitude data.

9. The grass detection method according to claim 8, wherein the step (5) is added with a step (6) of: communicatively connecting the lawn mower to the processing unit, and providing the lawn mower with a second positioning unit, wherein the second positioning unit may be configured to be communicatively connected to a virtual base station real-time kinematic (VBS-TRK) for acquiring a dynamic latitude and longitude coordinate data of the lawn mower; the lawn mower moves according to the dynamic latitude and longitude coordinate data and the grass ground contour latitude and longitude data.

10. The grass detection method according to claim 9, wherein between the step (5) and the step (6), a step (7) of, is further added: with the processing unit, setting a spiral motion path from the outside to the inside according to the grass ground marker block, and finding out a spiral motion path longitude and latitude data of the spiral motion path according to the comparison image data; in the step (6), the lawn mower moves along the spiral motion path according to the dynamic latitude and longitude coordinate data and the spiral motion path longitude and latitude data.
